(19) United States
(12) Patent Application Publication
(10) Pub. No.: US 2008/0114655 A1
(43) Pub. Date: May 15, 2008

(54) INTEGRATED HOME INSPECTION, WARRANTY AND VENDOR INFORMATION SYSTEM

(75) Inventor: Thomas Brent Skidmore, Greer, SC (US)

Correspondence Address: MCNAIR LAW FIRM, P.A., P.O. BOX 10827, GREENVILLE, SC, 29603-0827, US

(73) Assignee: Advantage Inspection International, LLC

(21) Appl. No.: 11/972,160

(22) Filed: Jan. 10, 2008

Related U.S. Application Data
(63) Continuation-in-part of application No. 10/202,596, filed on Jul. 24, 2002.
(60) Provisional application No. 60/314,462, filed on Aug. 23, 2001.

(51) Int. Cl. G06Q 30/00

(52) U.S. Cl. 705/14

(57) ABSTRACT

This invention is a system for creating an interactive home inspection report having an inspection item associated with a target property by receiving home inspection information, creating an electronic home inspection report, determining whether the inspection item needs maintenance or repair, receiving vendor information from the vendor computer readable medium associated with a vendor whose goods or services are associated with the inspection item if the inspection item needs maintenance or repair, generating an embedded link from the vendor information, including the inspection item and the embedded link in the home inspection report if the inspection item needs maintenance or repair so that a viewer of the electronic home inspection is provided with a link to the vendor content who provides good or services associated with the inspection item.

### CLAIM OF PRIORITY

This application is a continuation-in-part of non-provisional patent application Ser. No. 10/202,596 filed Jul. 24, 2002 which in turn claims priority on provisional patent application Ser. No. 60/314,462 filed on Aug. 23, 2001.

### FIELD OF THE INVENTION

The present invention is directed to an integrated computerized home inspection, warranty, and vendor information system; in particular, to a system for using collected information from a home inspection for customizing a home warranty system and providing vendor information for the home owner for any inspection items that were determined less than satisfactory.

### BACKGROUND OF THE INVENTION

The purchase of a home is usually the largest single investment the average person makes. As such, buyer should investigate the condition of the property as much as possible. The potential home buyer should particularly investigate the need for any major repairs that the home may need. It is the buyer who should attempt to reduce the risk of the purchase since; generally, the “buyer beware” doctrine applies. One way to reduce the risks of purchasing a home is to have a home inspection performed.

A home inspection is one tool used to help assure buyers that the home they are about to purchase is in an acceptable condition. Therefore, a home inspection has become an integral part of the home buying process. Inspections are requested by buyers either before they purchase a home or by sellers who are preparing to sell their home. The home inspection provides an opinion based upon objective criteria applied to physical observations of the home. Traditionally, the process involves recording observations, inspection results and opinions of the inspector onto a paper form. The inspection should include be a comprehensive inspection from the foundation to the roof and from the grounds to the interior. Only someone with specific knowledge of home construction, installation, maintenance and other home systems should perform the inspection to insure that a proper home inspection is conducted. Additionally, each inspector should follow a checklist to insure that all aspects of the inspection were performed and none were forgotten. Traditionally, paper forms show what should be inspected and provided a checklist, but little or no instruction is provided to assist the inspector in how to perform the inspection.

Home inspection reports are submitted to the party that requested the home inspection, traditionally in paper form. In order to provide this information to a buyer, seller, or a real estate agent, a copy of the form must be physically transmitted to each person. This process delays the purchase cycle as the parties await their individual paper copy of the inspection.

While home inspection does assist in reducing the risk associated with purchasing a home, it is certainly not the only means. Another method of reducing the risk associated with buying a home is for the buyer to purchase a home warranty insurance policy. A home warranty is an insurance policy designed to protect against repair and maintenance of a home. Generally, the home warranty industry uses a preexisting “blanket” home warranty policies that provide standard coverage to all that purchase such a policy. Since insurance companies offer these preexisting standard policies, these preexisting policies are not tailor or customized for each different home. For example, even though one home has a brand new roof and another home has a twenty-year-old roof, both home owners will receive the same policy even though there is substantially most risk associated with the older roof.

Because insurance companies do not consider the differences between the individual homes in creating homeowner polices and use preexisting policies, each policy holder shares the aggregate risk of all home owners who purchase policies. The combat this discrepancy, insurance companies set their premiums based upon the aggregate risk so that each homeowner is paying for the aggregate risk of all home owners. Additionally, insurance companies can exclude coverage from items of a home in an attempt to reduce the risk of having to pay claims. In some cases, insurance companies do both so that some home owners are both paying too much for their house in good repair and receiving less coverage from the preexisting policy.

Therefore, policy purchaser with a home in good repair is either paying higher premiums or not receiving the maximum coverage allowable. Therefore, a system allowing the customization of a home warranty policy based upon the actual home inspection results is a problem where significant attention needs to be directed be directed.

In the current home warranty insurance industry, insurance companies exclude certain items that are “high risk” items in an attempt to reduce the number of claims that have to be paid. However, these traditionally excluded items can be included without significantly increased risk if these items are in good repair and are within a predetermined age. Therefore, it would be advantageous to have a system for including items in a home warranty policy if, based upon the home inspection results, the items are in good repair and within a predetermined age.

When an item is found to be in disrepair, the homeowner should have the item repaired. In most states, home inspectors are legally prohibited from making repairs them selves so that the homeowner must find a home repair vendor to perform the repair. In many cases the home buyer is new to an area and does not have local information concerning who is a potential vendor to make such a repair. In any case, it would be advantageous for the home buyer or seller to be provided with a list of local vendors that can perform needed repairs as identified in a home inspection. Further, it would be advantageous to have a system that will include an inspected item in the home warranty policy if the homeowner repairs the item initially found to be in disrepair.

Accordingly, it is an object of the present invention to create a home inspection system with the ability to provide the inspection results to inspectors, realtors, buyers and sellers quickly and easily.

It is yet another object of the present invention to provide a system that allows inspection information to be used in creating a home warranty policy so that home warranty polices are customized for each home.

It is yet another object of the present invention to provide a system providing vendors for repairing an inspection item to a home owner or home buyer in the event that the home inspection reveals that the inspection item is in need of repair.

It is yet another object of this invention to provide for home warranty coverage of items that were initially found to be in need of repair if the item has been properly repaired.

### SUMMARY OF THE INVENTION

The above objects are achieved by providing a system for creating an interactive home inspection report having an inspection item associated with a target property comprising a inspection computer readable medium, a vendor computer readable medium in communications with the inspection computer readable medium, a set of vendor information stored on the vendor computer readable medium representing vendors that can provide goods or services associated with the inspection item and having vendor content associated with each vendor and, a set of computer readable instructions embodied in the inspection computer readable medium for receiving home inspection information representing the inspection of an inspection item, creating an electronic home inspection report according to the home inspection information, determining whether the inspection item needs maintenance or repair according to the home inspection information, requesting vendor information from the vendor computer readable medium for if the inspection item needs maintenance or repair, receiving vendor information from the vendor computer readable medium associated with a vendor whose goods or services are associated with the inspection item if the inspection item needs maintenance or repair, generating an embedded link from the vendor information, including the inspection item and the embedded link in the home inspection report if the inspection item needs maintenance or repair so that a viewer of the electronic home inspection is provided with a link to the vendor content who provides good or services associated with the inspection item. The vendor content can be content, or a link to other content such as the vendor's web page.

The invention can also include computer readable instructions for creating a home warranty policy according to the home inspection information that initially excludes an inspection item that is in need of maintenance or repair according to the home inspection information, receiving repair information representing that the inspection item has been repaired, and including the repaired inspection item in the home warranty policy so that the inspection item that are initially determined to be in need of maintenance or repair can be repaired and included in the home warranty policy.

The invention can also include computer readable instructions for creating a home warranty policy according to the home inspection information that calculates a premium if a covered inspection item is in need of maintenance or repair according to the home inspection information, receiving repair information representing that the inspection item has been repaired, and calculates a reduced premium according to the repair information so that home warranty insurance premiums are reduced if the inspection item that is initially determined to be in need of maintenance or repair is repaired.

The invention can also include vendor information that includes a service area associated with the vendor and computer readable instructions for only including the embedded link in the home inspection report if the vendor associated with the embedded link's service area contains the target property.

The invention can also include computer readable instructions for determining whether the inspection item was present in the target property, generating an embedded link from the set of vendor information associated with a vendor whose goods or services are associated with the inspection item on the electronic home inspection report if the inspection item was not present, including the inspection item and the embedded link in the home inspection report if the inspection item was not present so that a viewer of the electronic home inspection is provided with a link to the vendor content who provides good or services associated with the inspection item that was not present.

### BRIEF DESCRIPTION OF THE DRAWINGS

The invention will be more readily understood from a reading of the following specification and by reference to the accompanying drawings.

FIG. 1 is a schematic illustrating data and process flow of the invention;

FIG. 2 is a schematic illustrating the various components of the invention;

FIG. 3 is a flowchart of the invention;

FIG. 4 is a flowchart of the invention; and,

FIG. 5 is a schematic illustrating data and processing of the invention.

### DETAILED DESCRIPTION OF THE INVENTION

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated. An object or module is a section of computer readable code embodied in a computer readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein. The term “communications network” can include local area network, wide area network, telecommunications network, or the Internet. The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks. These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

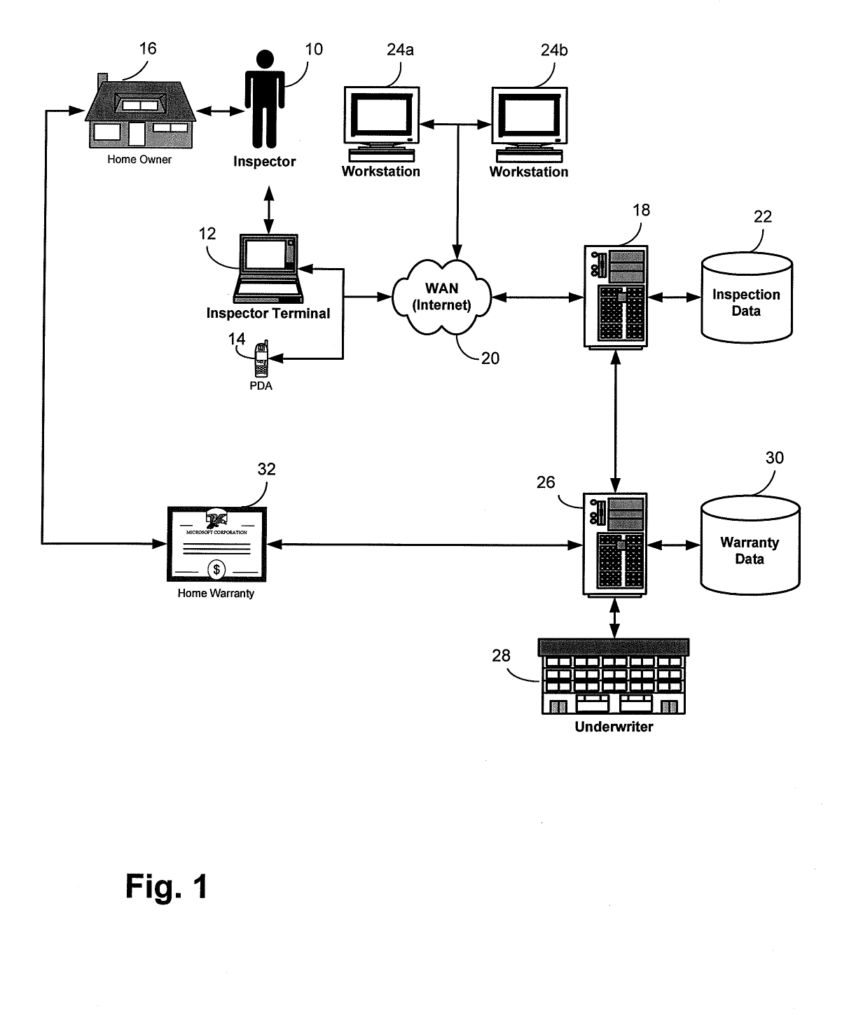

Referring now to FIG. 1, the process and data flows according to this invention are listed in further detail. In the operation of this invention in a preferred embodiment, a home inspector 10 is equipped with a computer readable medium such as an inspector terminal 12, a personal computer, lap top computer, personal digital assistant (PDA) 14 or other computer readable medium in which to record the home inspection results. In an alternative embodiment, paper forms can be used to record the home inspection results. The computer readable medium embodies computer readable instructions for providing the functionality of recording home inspection results. In another embodiment, the computer readable medium can include an operation manuals that can eb integrated within the computer readable instructions for assisting an inspector in the field, and other administration functionalities such as the ability to create correspondence to a client or real estate agent, generate invoices, and update account receivable records associated with the individual or entity who ordered the home inspection.

When a home inspection request is made, the target property 16 is identified and a time scheduled for the inspection. This information can be downloaded from a home office server 18 through a network 20 to provide for an automated scheduling system, allowing a home inspector to know of the inspections and their location to be performed. Upon receiving the home inspection request, the home inspector arrives at the target property and performs an inspection. The results of the inspection are recorded in the computer readable medium such as inspector terminal 12 or PDA 14 and transmitted back to server 18.

Once the inspection information is received, the inspection information can be stored in an inspection database 22 for subsequent retrieval. Once stored, the inspection information can be formatted into a home inspection report and made available for viewing through work stations 24A and 24B through wide area network 20. This allows a multitude of individuals or entities to view the results of the inspection since it is electronically available from home server 18. The home inspection report can be available from a website, email to recipients or requested to be received for subsequent email delivery or download. Therefore, the buyer, seller or real estate agent can retrieve or receive the home inspection report and view the results as soon as the home inspection report is available. This alleviates the need to mail hard copies to each party and expedites the purchase process by providing this information as soon as it is ready.

Once stored, the inspection information can be sent to an underwriter's server 26 of underwriter 28. The underwriter can use the inspection information to create a customized home warranty policy 32 that is based upon the inspection information. The home warranty information can be stored in home warranty database 30.

For example, the home inspection may reveal that there is substantial damage to the heat pump associated with the house. The underwriter, upon knowing this information, may decide not to warrant that particular appliance or may wish to adjust the premium to reflect the substantial damage to that particular appliance. In some cases, the underwriter may decide simply not to issue a policy is the heat pump it to be included in the covered items. Therefore, the home owner can voluntarily decide to exclude the heat pump from the home warranty policy or can have the heat pump repaired. If the heat pump is satisfactorily repaired, the heat pump can be included in the home warranty policy without the need for an premium increase.

By using the inspection information to create home warranty policy terms, a home warranty policy can be tailored for a specific home thereby allowing a homeowner to receive a policy that fits his or her needs. Once created, home warranty policy 32 is issued.

In another embodiment, the system can be tailored for specific inspection and warranty products rather than for complete home inspections and warranty products. For example, the system can be for inspecting a specific feature of the house such as stucco, mold, moisture issues, or other inspection items. In this embodiment, the specific inspection for the inspection item is performed, recorded, and stored in the computer readable medium. The home warranty policy can then be created according to the results of the stucco inspection so as to provide for a stucco home warranty policy.

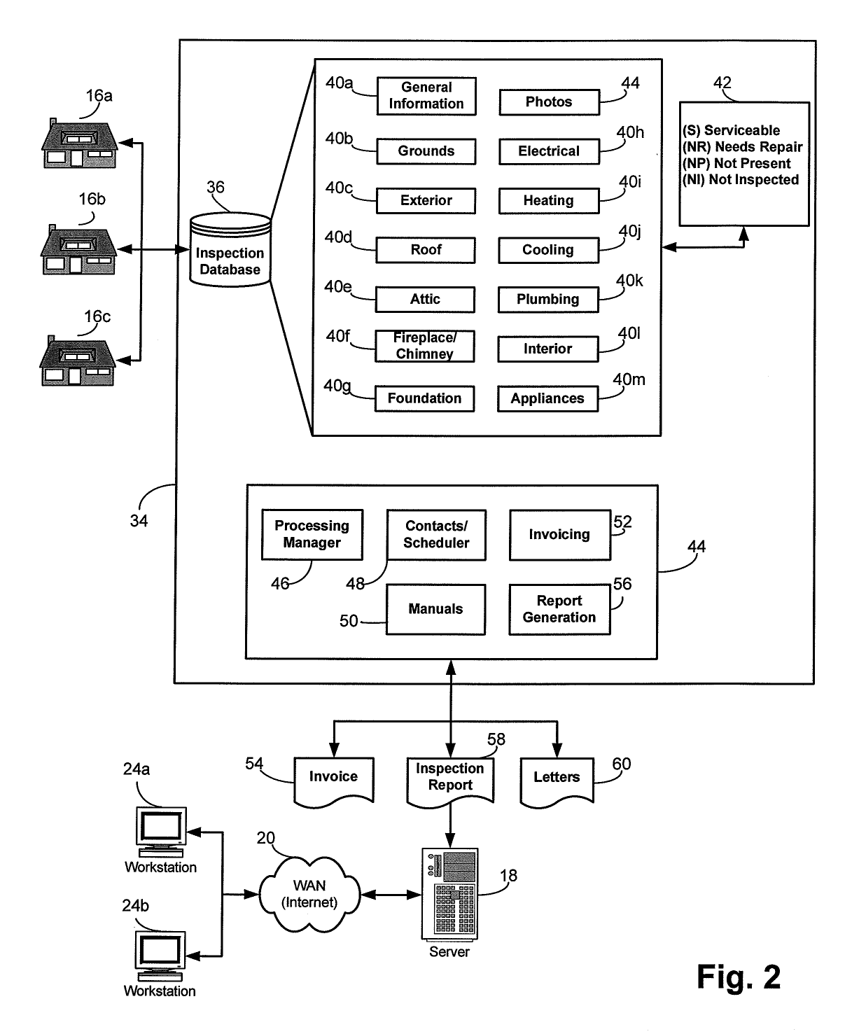

Referring now to FIG. 2, the computer readable instructions provided to the home inspector and their associated functionality are described in more detail. A computer readable medium 34 embodies computer readable instructions, which are a component of this invention. Inspection database 36 is incorporated in the computer readable medium and contains the inspection criteria to be followed by the home inspector. For example, if the home inspector were to inspect homes 16A, 16B, and 16C, the inspection database would have the results from each of those target properties. In the inspection itself, this invention records the inspection observations for each inspection item. Inspection items can include general information 40a that includes the age of the target property, the size, the address, the current owner and a visual representation, such as a photograph or digital image of the target home inspected. Inspection items concerning the grounds shown as 40b, include information concerning the grade and drainage of the property, the driveway, any outdoor lighting, and the condition of any trees and/or their associated limbs. Exterior inspection items 40c include information concerning the condition of any siding, shutters, soffits, porches, decks, windows, and garages. Roof inspection items 40d include the information concerning the roof material, the roof style, and the condition of any flashing, skylights or gutters. Attic inspection items 40e include the condition of framing, ceiling joists, ventilation and insulation. Fireplaces and chimney inspection criteria 40f with the existence of gas logs, the condition of the damper, flue liner, and chimney for each fireplace that may be located at the target property. Foundation inspection items 40g include information concerning the moisture penetration, wall material, girders, sub-floor, sump pumps for crawl spaces, ventilation, and insulation. Electrical inspection items 40h includes the condition of wiring, grounding equipment, electrical panels, electrical sub-panels, 110 volt circuits, 220 volt circuits, receptacles, lighting, fixtures and switches, and general safety concerns concerning the electrical systems. Heating inspection items 40i include the condition of the heating unit, its manufacturer, its capacity, its approximate age, and its location. Cooling inspection items 40j include information concerning the cooling unit similar to that recorded for the heating unit. For both the heating and cooling unit, information concerning the ducts or filters can also be included. Plumbing inspection items 40k includes information concerning the water supply, pipe system, wastewater disposal, plumbing fixtures, and water heater. Interior inspection items 40l include information concerning the rooms within the house, the floors and walls, any alarms, the ceiling, and any stairs or doors. Appliance inspection criteria 40m includes information concerning the appliances contained within the home such as dishwasher, washer/dryer, refrigerator, trash compactor, or microwave. For each of the inspection items, one embodiment contains four categories representing the condition of the particular item being inspected. Categories 42 contain the designation, (S), representing that the particular item is serviceable. The second designation, (NR), represents that the particular item needs repair. In this case, the item must be repaired before the home inspection would show the particular item as serviceable. This information is important to the buyer as well as for the home warranty policy since an item that is in need of repair may both prevent the buyer from purchasing the home as well as preventing a home warranty policy from covering such an item. The seller would then be informed as to the item needing repair and remedial measures can be taken to hopefully move the item into a state of serviceability. The third designation, (NP), represents that the item is not present. The fourth designation, (NI), represents the fact that the item was not inspected. For these items, further inquiry must be made as to why a particular item was not inspected. In order to further illustrate the condition of the property as well as to merely identify the property itself, a photo 44 can be included with the inspection information stored in inspection database 36 so as to provide a visual representation of the inspected property.

Also contained within computer readable medium 34 are modules 44 which provide functionality of the present invention. A processing manager 46 generates a request to inspect a target property. When the target property is to be inspected, the contacts associated with the target property and a time when the inspection is scheduled is provided by the requesting party and contact scheduler module 48 allows for the recording of this information and scheduling of an inspection. By having this module embodied in the computer readable medium of the home inspector, the schedule of inspections to be performed can be automatically generated and provided to the home inspector. During the course of performing the inspection, an inspection manual 50 can also be embodied in computer readable medium 34. By having a detailed manual on the operation and inspection of a target property, the home inspector has an in field, on line means for obtaining an explanation on how to inspect a particular item. For example, if a home inspector is in need of information for inspecting a heat pump, the home inspector can merely refer to the on-line manual which will give a detailed explanation of the steps to be performed and their relationship with the inspection according to that particular item. Once the inspection is complete, invoicing module 52 can generate an invoice for the inspection and can create and provide a hard copy invoice 54 according to the purchase information covered by the purchase manager and the contact information contemporaneously obtained. The report generator 56 formats the results of the inspection into a useable format to produce inspection report 58. This inspection report, both in hard and soft copy, can be transmitted to the home office server 18 and is thereby made available through wide area network 20 to work stations 24a and 24b. Associated with transmitting the invoice and inspection reports, it may be necessary to provide correspondence to the involved individuals. In this case, correspondence 60 can be generated by any of the modules before transmission to the respective entities. For example, the purchase manager may generate a “thank you” letter to be sent upon receiving an inspection order; the invoicing manager may create a cover letter to be provided with each invoice transmitted; or the report generator may generate a cover letter that accompanies the inspection report.

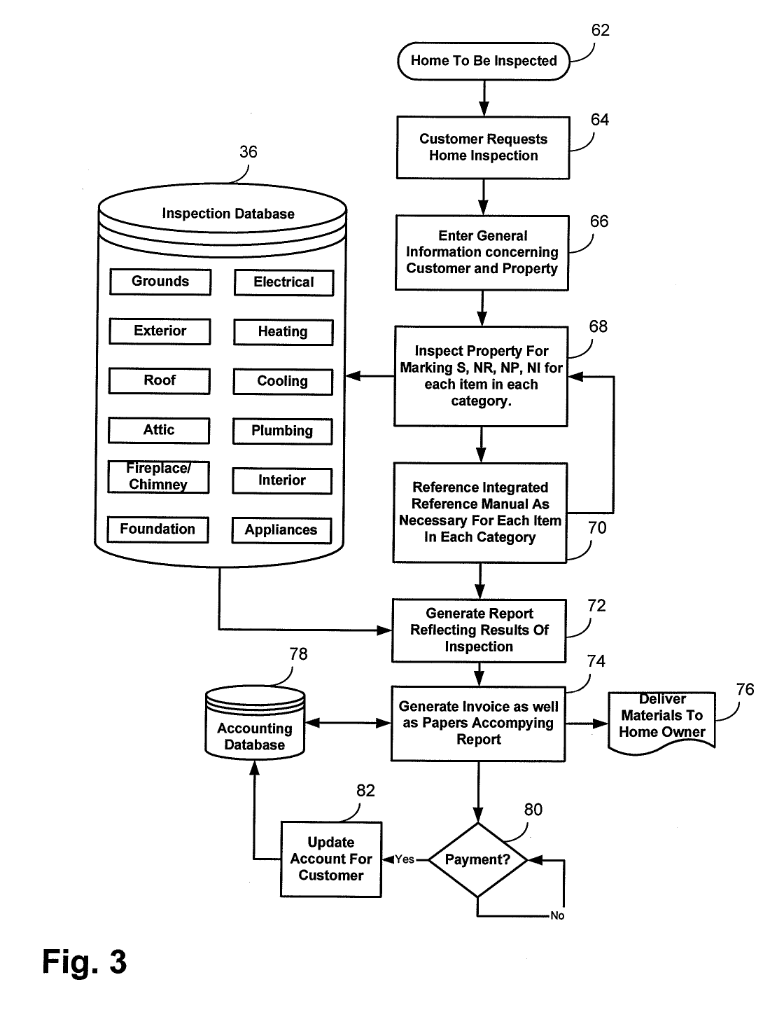

Referring now to FIG. 3, the specific steps involved in association with this invention are further illustrated. In step 62 it is known that a home needs to be inspected. Therefore, the customer requests a home inspection in step 64. General information concerning the customer and the target property are collected in step 66 and can be stored in a computer readable medium. Therefore, the customer, target property, and scheduling information can be transmitted or provided to a home inspector so as the home inspector can commence a home inspection. Thereafter, the home inspector inspects the property in step 68 and for each item contained in inspection database 36, a marking of (S), (NR), (NP) or (NI) is recorded for each item. During the course of the inspection, the home inspector may need to reference the integrated manual in step 70 for each item in each category. Upon completion of the inspection, the data for the home inspection is formatted and the report is generated in step 72. The invention may also generate an invoice in step 74 which can be delivered with the home inspection report in step 76. An entry can be made upon generation of an invoice and an accounting database 78 showing that the customer has an accounts receivable balance due the home inspector. Upon receipt of payment of the invoice in step 80, the account for the particular customer can be updated in step 82, showing a credit to the accounts receivable balance for that particular customer according to the received payment.

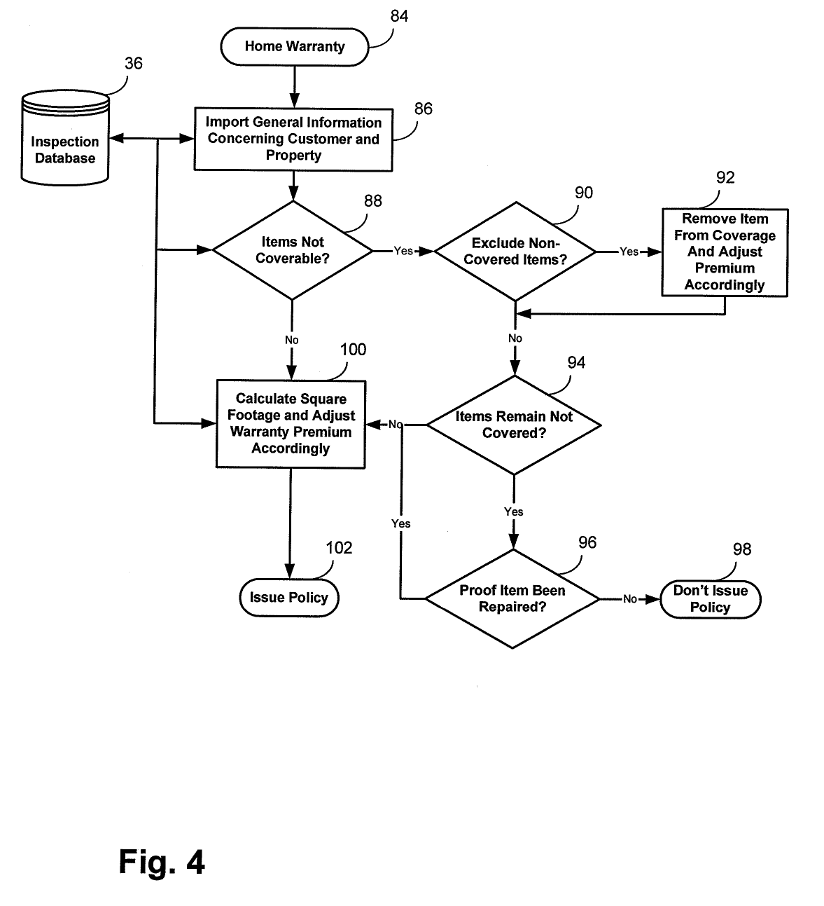

Referring now to FIG. 4, once home inspection is completed, there should be sufficient information for a home warranty underwriter to be able to provide a home warranty. In any event, a home warranty is requested in step 84. Information concerning the customer and the target property are imported from inspection database 36 in step 86. According to the information retrieved from the inspection database concerning the target property, a determination is made in step 88 as to what items are not coverable. For example, any item that has a designation of NR, or NP, would not automatically be covered since they would be respectively in need of repair or not present. In the event that an item is not covered, a determination is made in step 90 as to whether to exclude that particular item from coverage. If so, the item is removed from coverage and a premium may be adjusted accordingly in step 92. If, however, an item is not coverable and is not excluded, there remains an item 6 that is not covered in step 94. In this case, there needs to be a determination made as to whether the item has been satisfactorily repaired in step 96. If not, the policy cannot be issued because there are items for which coverage would normally not apply both for which the disposition of has not been determined. However, if it is shown that the item not covered has been satisfactorily repaired, then the item can be covered and further calculations of square footage for the target property is determined and if the property's square footage is above the predetermined value, the premium can be adjusted accordingly. Once the items that have not been covered are disposed of and the additional calculations for home warranty policies are made, a policy can be issued to the homeowner in step 102.

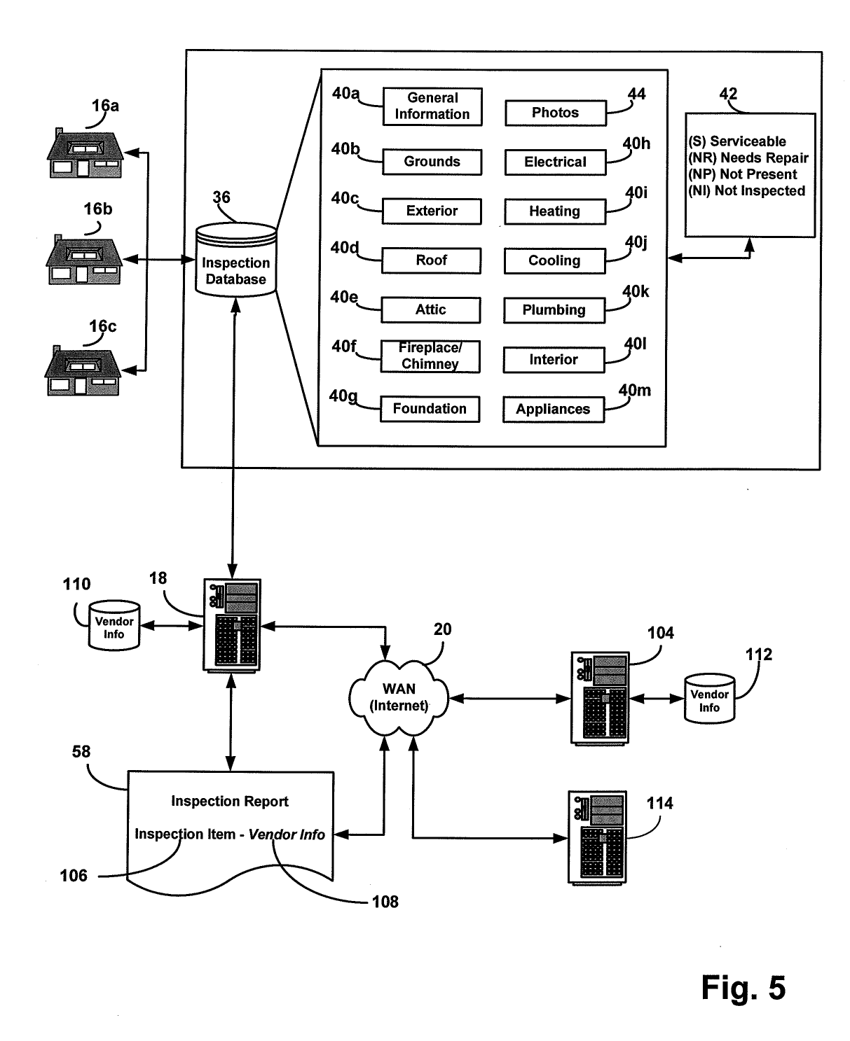

Referring now to FIG. 5, inspection database 36 is shown and can contain inspection items that are in need of repair which can be shown through the NR designation. Vendor database 118 can be contained in a computer readable medium of the office server 18 or in a separate vendor server. The vendor records are associated with repair items so that the database can be queried for vendors that provide repair services for a specific inspection item. For example, if vendor A provides repair service for appliances, Vendor A can be associated with appliances such as dishwasher, refrigerator, washer, dryer, trash compactor and other such household appliances. Therefore, when the vendor database is queried for vendors that can provide repair service for dishwashers, Vendor A will be returned.

The vendor database can also contain the physical location of the vendors. Additionally, the service area of the vendors can be included in the vendor database. The service area is the geographic area where the vendor is willing to travel to perform his or her services. Since the inspection information contains the physical address of the target property, a query can be made into the vendor database for vendors that perform repair service for a specific item that are within a predetermined geographic distance or that have a service area that includes the target property.

When computer readable instructions create a home inspection report from the inspection information, the computer readable instructions can also include a list of vendors retrieved from the vendor database that offer repair services for inspection items that were discovered to be in need of repair. For example, the home inspection report can include the inspected item 106 having the status of NR for need repair. The home inspection report can then include on the report information for vendors that are retrieved from the vendor database that can repair the associated inspection item. By way of example, the report can contain the text:

| | |
|---|---|
| AT LEAST THREE ROOF SHINGLES WERE | Vendors that can |
| LOOSE AND NEED TO BE REPLACED ON | repair this item are: |
| THE RIGHT REAR OF HOUSE - PROBABLY | VENDOR A |
| STORM DAMAGE. | VENDOR B |

When the list of vendors is shown (VENDOR A and VENDOR B in the above example), the text VENDOR A can be electronic link 108 to vendor content that is specific to that vendor. For example, the text VENDOR A on the home inspection report can be an embedded link or hyperlink to that reference vendor content stored in vendor database 119 or to another server so that when the link is actuated, vendor content associated with that vendor is provided to the viewer of the home inspection report. Vendor content that can be displayed includes the vendor's website, marketing material, contact information, promotional information, such as coupons, specials, sales, etc. Therefore, in one embodiment, the vendor can be responsible for the vendor content associated with the vendor and the home inspection system need only provide a link to vendor content maintained by the vendor. The link to vendor content can be incorporated into the home inspection report or can be displayed electronically to the viewer of the home inspection report. On one embodiment, link 108 actuates computer readable instructions that retrieves vendor content from vendor database 118. In another embodiment, link 108 is an embedded link to vendor content on a web server 114 so that a web page can be displayed when link 108 is actuated. On one embodiment, vendor content can be retrieved from vendor server 104 having vendor content information 112 so the when link 108 is actuated, vendor content from vendor content server 112 is displayed to the viewed of the home inspection report.

For vendors, it is advantageous to be included in the vendor database. Therefore, computer readable instructions on office server 18 allow for receiving vendor information and storing such information in vendor database 118. Vendor database 118 can be a protected server so that access is limited or can be readily accessible directly by vendors so that vendor information can be updated by vendors themselves. Vendors can enter vendor information and, in one embodiment, pay a fee to be listed in the vendor database. In this embodiment, computer readable instructions can be included to prevent the vendor from being displayed to a viewer of the home inspection report unless the vendor's balance is current.

For vendors, it is also advantageous to be at the top of a list of vendors when multiple vendors are displayed for an inspection item that need repair. Therefore, in one embodiment, vendors can be displayed in preferential order so that specific vendors can be displayed at the top of the list when included in the home inspection report.

In one embodiment, vendor information can also be included for inspection items that were not present during the home inspection. For example, if the home inspection revealed that the dishwasher was not present, the home inspection report can include vendors that sell dishwashers associated with the inspection item dishwasher. Therefore, the viewer of the home inspection report is provided with a list of vendors that can sell the inspection item that was not present in the event that the view of the home inspection report wishes to purchase the inspection item.

It is to be appreciated by the skilled artisan that the description above is not limited to just homeowners and houses, but is applicable to any building and the building may be used for residential or non-residential purposes.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A system for creating an interactive home inspection report having an inspection item associated with a target property comprising:
a computer readable medium;
a set of vendor information stored on said computer readable medium representing vendors that can provide goods or services associated with the inspection item and having vendor content associated with each vendor; and,
a set of computer readable instructions embodied in said computer readable medium for receiving home inspection information representing the inspection of an inspection item, creating an electronic home inspection report according to said home inspection information, determining whether said inspection item needs maintenance or repair according to said home inspection information, generating an embedded link from said set of vendor information associated with a vendor whose goods or services are associated with said inspection item on said electronic home inspection report if said inspection item needs maintenance or repair, including said inspection item and said embedded link in said home inspection report if said inspection item needs maintenance or repair so that a viewer of said electronic home inspection is provided with a link to said vendor content who provides good or services associated with said inspection item.

2. The system of claim 1 including a set of computer readable warranty creation instructions embodied in said computer readable medium for creating a home warranty policy according to said home inspection information that initially excludes an inspection item that is in need of maintenance or repair according to said home inspection information, receiving repair information representing that said inspection item has been repaired, and including said repaired inspection item in said home warranty policy so that said inspection item that are initially determined to be in need of maintenance or repair can be repaired and included in said home warranty policy.

3. The system of claim 1 including a set of computer readable warranty creation instructions embodied in said computer readable medium for creating a home warranty policy according to said home inspection information that calculates a premium if a covered inspection item is in need of maintenance or repair according to said home inspection information, receiving repair information representing that said inspection item has been repaired, and calculates a reduced premium according to said repair information so that home warranty insurance premiums are reduced if said inspection item that is initially determined to be in need of maintenance or repair is repaired.

4. The system of claim 1 wherein:
said vendor information includes a service area associated with said vendor; and,
said computer readable instructions include instructions for only including said embedded link in said home inspection report if said vendor associated with said embedded link's service area contains the target property.

5. The system of claim 1 wherein said embedded link is a link to said vendor's web page so that actuating said embedded link from said home inspection report displays said vendor's web page.

6. The system of claim 1 wherein said computer readable instructions include instructions for determining whether said inspection item was present in the target property, generating an embedded link from said set of vendor information associated with a vendor whose goods or services are associated with said inspection item on said electronic home inspection report if said inspection item was not present, including said inspection item and said embedded link in said home inspection report if said inspection item was not present so that a viewer of said electronic home inspection is provided with a link to said vendor content who provides good or services associated with said inspection item that was not present.

7. The system of claim 1 wherein said computer readable instructions include instruction for delivering said home inspection report electronically so that said the viewer of said home inspection report can use said embedded link for viewing vendor content.

8. A system for creating an interactive home inspection report having an inspection item associated with a target property comprising:
a inspection computer readable medium;
a vendor computer readable medium in communications with said inspection computer readable medium;
a set of vendor information stored on said vendor computer readable medium representing vendors that can provide goods or services associated with the inspection item and having vendor content associated with each vendor; and,
a set of computer readable instructions embodied in said inspection computer readable medium for receiving home inspection information representing the inspection of an inspection item, creating an electronic home inspection report according to said home inspection information, determining whether said inspection item needs maintenance or repair according to said home inspection information, requesting vendor information from said vendor computer readable medium for if said inspection item needs maintenance or repair, receiving vendor information from said vendor computer readable medium associated with a vendor whose goods or services are associated with said inspection item if said inspection item needs maintenance or repair, generating an embedded link from said vendor information, including said inspection item and said embedded link in said home inspection report if said inspection item needs maintenance or repair so that a viewer of said electronic home inspection is provided with a link to said vendor content who provides good or services associated with said inspection item.

9. The system of claim 8 including a set of computer readable warranty creation instructions embodied in said inspection computer readable medium for creating a home warranty policy according to said home inspection information that initially excludes an inspection item that is in need of maintenance or repair according to said home inspection information, receiving repair information representing that said inspection item has been repaired, and including said repaired inspection item in said home warranty policy so that said inspection item that are initially determined to be in need of maintenance or repair can be repaired and included in said home warranty policy.

10. The system of claim 8 including a set of computer readable warranty creation instructions embodied in said inspection computer readable medium for creating a home warranty policy according to said home inspection information that calculates a premium if a covered inspection item is in need of maintenance or repair according to said home inspection information, receiving repair information representing that said inspection item has been repaired, and calculates a reduced premium according to said repair information so that home warranty insurance premiums are reduced if said inspection item that is initially determined to be in need of maintenance or repair is repaired.

11. The system of claim 8 wherein:
said vendor information includes a service area associated with said vendor; and,
said computer readable instructions include instructions for only including said embedded link in said home inspection report if said vendor associated with said embedded link's service area contains the target property.

12. The system of claim 8 wherein said vendor content is a link to said vendor's web page so that actuating said embedded link from said home inspection report displays said vendor's web page.

13. The system of claim 8 wherein said computer readable instructions include instructions for determining whether said inspection item was present in said target property, generating an embedded link from said set of vendor information associated with a vendor whose goods or services are associated with said inspection item on said electronic home inspection report if said inspection item was not present, including said inspection item and said embedded link in said home inspection report if said inspection item was not present so that a viewer of said electronic home inspection is provided with a link to said vendor content who provides good or services associated with said inspection item that was not present.

14. The system of claim 8 wherein said computer readable instructions include instruction for delivering said home inspection report electronically so that said the viewer of said home inspection report can use said embedded link for viewing vendor content.

15. A system for creating an interactive home inspection report having an inspection item associated with a target property comprising:
an computer readable medium;
a set of vendor information stored on said computer readable medium representing vendors that can provide goods or services associated with the inspection item and having vendor content location information identifying the location of vendor content associated with each vendor; and,
a set of computer readable instructions embodied in said computer readable medium for receiving home inspection information representing the inspection of an inspection item, creating an electronic home inspection report according to said home inspection information, determining whether said inspection item needs maintenance or repair or was not present during the inspection process according to said home inspection information, generating an embedded link from said set of vendor information associated with a vendor whose goods or services are associated with said inspection item on said electronic home inspection report if said inspection item needs maintenance or repair or was not present, including said inspection item and said embedded link in said home inspection report if said inspection item needs maintenance or repair so that a viewer of said electronic home inspection is provided with a link to said vendor content who provides good or services associated with said inspection item.

16. The system of claim 15 including a set of computer readable warranty creation instructions embodied in said computer readable medium for creating a home warranty policy according to said home inspection information that initially excludes an inspection item that is in need of maintenance or repair or was not present according to said home inspection information, receiving repair information if said inspection item was repaired, including said repaired inspection item in said home warranty policy according to said repair information if said inspection item was repaired, receiving existence information if said inspection item was purchase, and including said purchased item in said home warranty policy if said inspection item was purchased.

17. The system of claim 15 wherein:
said vendor information includes a service area associated with said vendor; and,
said computer readable instructions include instructions for only including said embedded link in said home inspection report if said vendor associated with said embedded link's service area contains the target property.

18. The system of claim 15 wherein said embedded link is a link to said vendor's web page so that actuating said embedded link from said home inspection report displays said vendor's web page.

19. The system of claim 15 wherein said computer readable instructions include instruction for delivering said home inspection report electronically so that said the viewer of said home inspection report can use said embedded link for viewing vendor content.
